(19) United States
(12) Patent Application Publication
(10) Pub. No.: US 2007/0262977 A1
(43) Pub. Date: Nov. 15, 2007

(54) AUTOMATIC DISPLAY POWER UP METHOD AND DISPLAY DEVICE USING THE SAME

(75) Inventor: Cheng-Chieh Liu, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/745,943

(22) Filed: May 8, 2007

(30) Foreign Application Priority Data
May 10, 2006 (TW) TW95116512

(51) Int. Cl. G09G 5/00

(52) U.S. Cl. 345/211

(57) ABSTRACT

A method for automatically powering up a display and a display using the same are disclosed. When a display device is connected to power from power disconnection, a flag is set as a power-on status. It is then determined whether a display signal is received by the display device, wherein the display device presents an image according to the display signal. When the flag is the power-on status and the display signal is received by the display device, the display device is caused to power up and present the image automatically.

### BACKGROUND

The invention relates to an automatic display power up method, and more particularly to a method for detecting the status of a display device and automatically powering up the display device when the display device is connected to power from power disconnection.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Some conventional electronic devices, such as personal computers (PC) or television sets, are equipped with both a host and a display device. The display device can have an indirect power supply, for example, power may be supplied through the electronic device, or a direct power supply independent from the electronic device. Regardless of whether the display device is supported by a direct or indirect power supply, manual operation is required to power up the display device when the display device is plugged in for the first time.

The conventional method may cause inconvenience under some circumstances. For example, in a shopping mall, cybercafe or other places quipped with numerous electronic devices, each of the electronic devices is positioned, and connected to a display device and power supply. Manual operation is subsequently required to power up each of the display devices. When there are a great number of electronic devices, manually turning on the display devices is labor intensive. For example, a shopping mall is equipped with 200 electronic devices, each equipped with a host and a display device. After these electronic devices are positioned, these hosts and display devices are connected to power supply. Additional manual operation is then required to power up these display devices.

Accordingly, there is a need for system that enables automatic power up for a display device.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The invention provides a method for detecting a status of a display device and automatically powering up display devices.

An automatic display power up method is provided. When a display device is connected to power from power disconnection, a flag is set as a power-on status in the display device. The flag is stored in a chip of the display device.

It is determined whether a display signal is received by the display device. Here, the display signal comprises information pertaining to image display, wherein the display device presents an image according to the display signal. The display device is coupled with a host, such as a personal computer or a television set. For example, in a personal computer, the display signal is generated by a display card of the host, and transmitted from the host to the display device. For a television set, the display signal is generated from a cable TV network or DVD player, and is transmitted to the television set.

When the flag is the power-on status and the display device receives the display signal, the display device is directed to automatically power up. After the display device automatically powers up, the flag is reset as a clear up status.

Also provided is a display device, comprising a chip storing a computer program. The controller is coupled to the chip and executes the computer program. When the display device is connected to power from power disconnection, the controller sets a flag as a power-on status in the display device and determines whether a display signal is received by the display device, wherein the display device presents an image according to the display signal. When the flag is the power-on status and the display signal is received by the display device, the controller causes the display device to automatically power up and present the image.

### BRIEF DESCRIPTION OF DRAWINGS

The invention can be more fully understood by reading the subsequent detailed description and examples with references made to the accompanying drawings, wherein:

FIG. 1 is a flowchart of an embodiment of an automatic display power up method;

FIG. 2 is a diagram of an embodiment of a storage medium for storing a computer program providing the automatic display power up method;

FIG. 3 is a schematic view of an embodiment of a display; and

FIG. 4 is a flowchart of an embodiment of the automatic display power up method.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

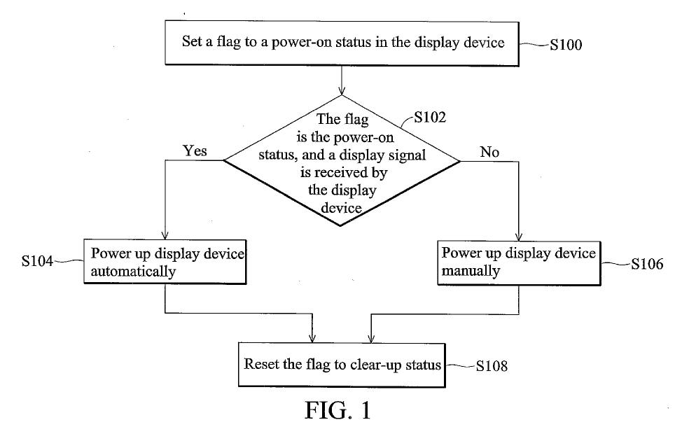

FIG. 1 is a flowchart of an embodiment of an automatic display power up method. When a display device is connected to power from power disconnection, a flag is set as a power-on status in the display device (step S100). The flag is stored in a chip of the display device. In step S102, it is determined whether a display signal is received by the display device.

Here, the display signal comprises information pertaining to image display, wherein the display device presents an image according to the display signal. The display device is coupled with a host, such as personal computer or a television set. For example, in the personal computer, the display signal is generated by a display card of the host, and is transmitted from the host to the display device. For a television set, the display signal is generated from a cable TV network or DVD player, and is transmitted to the television set.

The display device is directed to automatically power up when the flag is the power-on status and the display signal is received (step S104). When the flag is not the power-on status or the display device has not received the display signal, the display device can not power up automatically, and manual operation is required to power up the display device (step S106). After the display device automatically powers up or is powered up manually, the flag is reset as clear up status (step S108).

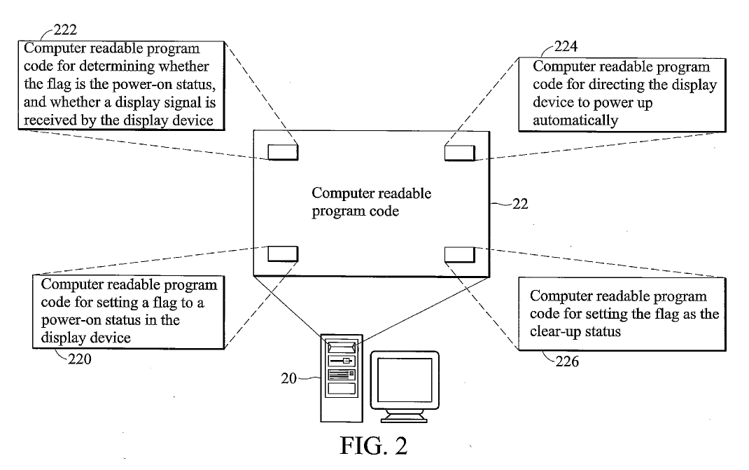

FIG. 2 is a diagram of an embodiment of a storage medium for storing a computer program providing the automatic display power up method. The computer program system comprises a computer usable storage medium 20 having computer readable program code 22 embodied in the medium, when the computer readable program code 22 is loaded in and executed by a computer system, the computer readable program code 22 directs the computer to perform the described automatic display power up method. The computer readable program code 22 comprises computer readable program code 220 for setting a flag as a power-on status in the display device, a computer readable program code 222 for determining whether the flag is the power-on status and whether a display signal is received by the display device, a computer readable program code 224 for directing the display device to power up automatically, and a computer readable program code 226 for setting the flag as the clear up status.

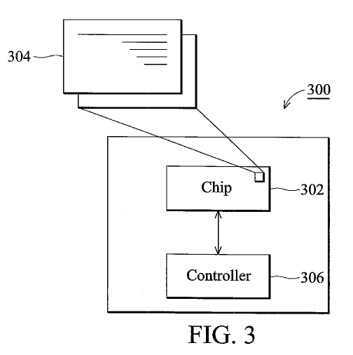

FIG. 3 is a schematic view of an embodiment of a display. A display device 300 is provided, comprising chip 302 storing a computer program 304. The chip 302 is coupled to a controller 306, such as a Micro Control Unit (MCU), of the display device 300, thereby the described automatic display power up method can be executed accordingly.

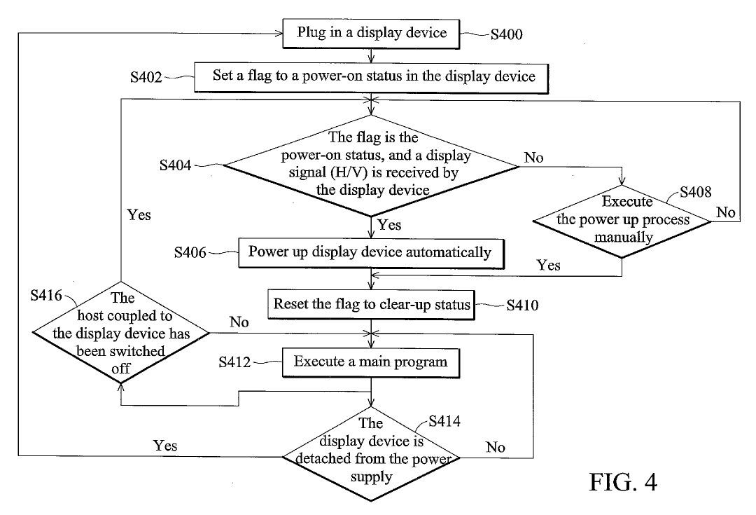

FIG. 4 is a flowchart of an embodiment of the automatic display power up method. First, a display device is connected to power from power disconnection (step S400). The display device can have an indirect power supply, for example, through the electronic device, or a direct power supply independent from the electronic device. When the display device is connected to power from power disconnection, a flag is set as a power-on status in the display device (step S402). For example, the flag is set as 1, indicating the power-on status. The flag can be set and stored in a chip of the display device. In step S404, it is determined whether the flag is the power-on status, and also determined whether a display signal is received by the display device.

Here, the display signal comprises information pertaining to an image display, such as R, G, B or H/V information pertaining to the image display. The display device presents an image according to the display signal. For example, in the personal computer, the display signal is generated by a display card of the host, and is transmitted from the host to the display device. For a television set, the display signal is generated from a cable TV network or DVD player, and is transmitted to the television set.

When the flag is the power-on status and the display signal is received by the display device, the display device is directed to power up automatically (step S406). When the flag is not the power-on status or the display signal has not been received by the display device, the method proceeds to step S408 to determine whether to execute the power up process manually, and if so, the method proceeds to step S410 to power up the display device manually, and the flag is reset as clear up status. If the power up process is not executed manually, the method returns to step S404.

After the display device automatically powers up or is powered up manually, the flag is reset as a clear up status (step S410). For example, the flag is set as 0, indicating the clear up status. Then, the controller executes a main program or other computer code (step S412) to process the display signal and present an image according to the display signal. In step S414, it is determined whether the display device is disconnected from the power supply. If the power supply is disconnected from the display device and then re-connected, the method returns to step S400. If the power supply remains connected to display device, the method returns to step S412.

In step S412, it is also determined, before checking the power supply of the display device, whether the host coupled to the display device has been switched off. For example, prior to disconnecting the power supply from the host or television set, it is determined whether the host coupled to the display device has been switched off (step S416). If the host is switched off, the method returns to step S404, otherwise, to step S412.

Accordingly, when the host is switched off and the display device is connected to power from power disconnection, no display signal is transmitted to the display device, and the automatic power up method is not executed, even though the flag is set as 1, indicating power-on status. Put simply, step S408, rather than step S406, is executed after the step S404.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic display power up method, comprising:
setting a flag as a power-on status in a display device when a display device is connected to power from power disconnection;
determining whether a display signal is received by the display device, wherein the display device presents an image according to the display signal; and
directing the display device to automatically power up and present the image when the flag is the power-on status and the display signal is received.

2. The automatic display power up method of claim 1, further comprising setting the flag as a clear up status after the display device automatically powers up.

3. The automatic display power up method of claim 1, wherein the flag is stored in a chip of the display device.

4. The automatic display power up method of claim 1, wherein the display device is coupled with a host, and the display signal is transmitted from the host to the display device.

5. The automatic display power up method of claim 4, wherein the display signal is generated by a display card of the host.

6. A display device, comprising:
a chip storing a computer program; and
a controller coupled to the chip and executing the computer program,
when the display device is connected to power from power disconnection, setting a flag as a power-on status in the display device, determining whether a display signal is received by the display device, wherein the display device presents an image according to the display signal, and when the flag is the power-on status and the display signal is received by the display device, causing the display device to automatically power up and present the image.

7. The display device of claim 6, wherein the controller further sets the flag as a clear up status after the display device automatically powers up.

8. The display device of claim 6, wherein the controller further stores the flag in the chip.

9. The display device of claim 6 is further coupled with a host, and receives the display signal from the host.

10. The display device of claim 9, further receives the display signal generated by a display card of the host.
